(19) United States
(12) Patent Application Publication
(10) Pub. No.: US 2008/0018619 A1
(43) Pub. Date: Jan. 24, 2008

(54) METHOD AND SYSTEM FOR ELECTRONICALLY STORING DATA ON A DOCUMENT

(75) Inventors: David Neil SLATTER, Bristol (GB); Guy ADAMS, Stroud Glos (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/770,222

(22) Filed: Jun. 28, 2007

(30) Foreign Application Priority Data
Jul. 4, 2006 (GB) 0613145.2

(51) Int. Cl. G06K 11/06

(52) U.S. Cl. 345/179

(57) ABSTRACT

A method of recording data in a data storage medium affixed to a document, the document having a document ID printed thereon and the data storage medium having the document ID stored therein, the method comprising capturing data written onto the document by means of a digital pen, the digital pen having an imaging system, determining, by means of the imaging system of the digital pen, the document ID printed on the document; comparing the document ID determined by the digital pen with the document ID stored in the data storage medium and on if there is a match transferring the captured data from the digital pen to the data storage medium.

Since the introduction of computerised word processing and other related applications, there has been a desire to convert handwritten information to an electronic form. Initially, using scanning technology, it was possible to capture an electronic image of hand generated documents and subsequently it became possible to apply optical character recognition techniques and handwriting recognition techniques to the electronic images to convert them into electronically editable text formats. A later development was the introduction of digital pens, which have the general appearance of a conventional pen and allow a user to make handwritten notes on paper whilst electronically recording the pen strokes made by the pen. This is accomplished by equipping the pen with a small camera and suitable processing capability to allow images of the pen strokes recorded by the camera to be analysed and accurately converted to electronic text data. The processed data is generally stored in memory incorporated within the digital pen and periodically transferred to a separate computing system. An example of such a digital pen is the Logitech™io₂ that is capable of storing up to 856 Kb of data (equivalent to approximately 40 pages of handwritten notes). The stored data is transferred via a USB cradle, which also serves to recharge the internal batteries of the pen, that is connected to either a personal computer or a network server. Such digital pens must be used with special paper that has a pattern of very small dots printed on the paper, the pattern being perceived by the human eye as a slightly off-white colour. Just a very small portion of the total pattern is sufficient to uniquely define its position within the full pattern. When writing on such paper, a digital pen uses its integrated camera and imaging system to continuously take snapshots of the pattern in view of the pen. Each snapshot contains sufficient information from the pattern to allow the pens processor to calculate the position of the pen and thus determine movement of the pen nib. An example of such paper is that produced by Anoto AB. The Anoto pattern consists of small dots with a nominal spacing of 0.3 mm. The dots are slightly displaced from a grid structure to form the proprietary Anoto pattern. Since the pattern of dots on the paper allows the digital pens to determine their position on the paper, it is possible to use predetermined page templates that allow a digital pen to know where on the paper certain page elements are positioned. The pen can therefore immediately determine that a pen stroke has been made in a particular place and perform an associated task, for example sending a copy of the recently recorded text as an e-mail or transferring the data recorded and stored on the digital pen to a connected computer system.

In the above systems there is no association between the paper copy of the document and the electronic copy of the document once the electronic data has been transferred from the digital pen to the connected computer system. This type of association can be achieved by providing the paper document with some type of electronic data storage. In European patent application EP 1 403 755 an RFID tag is embedded or fixed to each paper document such that electronic data associated with the document, or an electronic copy of the document itself, can be stored on the RFID tag itself. The data is written to the RFID tag using an appropriate RFID tag writer incorporated within the digital pen. In the system proposed in EP 1 403 755 the data captured by the digital pen is sent first to an associated computing system before at least a portion of the data is transmitted back from the computing system to the digital pen and subsequently recorded on the RFID tag embedded in the paper document. Consequently, until the data has been transmitted to the RFID tag from the digital pen there is no particular association between the digital pen, paper document and RFID tag. This could be problematic where a higher degree of security is desirable, since it does not prevent data transmitted back to a digital pen from the computing system being recorded in an RFID tag embedded to a paper document that is different from the paper document on which the original handwritten information was written. Furthermore, if a number of documents each having an embedded RFID tag were within the range of transmission of the RFID writer on the digital pen, which in conventional RFID systems can be tens of centimetres, there is a possibility of data being written to either the incorrect paper document or to multiple paper documents in an undesired manner.

According to a first aspect of the present invention there is provided a method of recording data in a data storage medium affixed to a document, the document having a document ID printed thereon and the data storage medium having the document ID stored therein, the method comprising capturing data written onto the document by means of a digital pen, the digital pen having an imaging system, determining by means of the imaging system of the digital pen the document ID printed on the document, reading the document ID stored on the data storage medium and comparing the document ID determined by the digital pen with the document ID stored on the data storage medium and only if there is a match then transferring the captured data from the digital pen to the data storage medium.

Preferably, prior to transferring the captured data the digital pen is placed within a predetermined distance from the data storage medium. Additionally, the predetermined distance may be 5 mm.

Additionally or alternatively, the document ID may be located on the document within the predetermined distance from the data storage medium.

Additionally or alternatively, the document ID may comprise a data item uniquely identifying the document additionally or alternatively, the document ID may be in an encoded format.

Additionally or alternatively, the document ID may be located on the document at a plurality of locations.

According to a further aspect of the present invention there is provided a system for recording data in a data storage medium affixed to a document, the system comprising a document having a document ID printed thereon a data storage medium affixed to the document and having the document ID stored therein and a digital pen having an imaging system arranged to determine the document ID printed on the document and capture data written on the document by the digital pen, a transceiver for transferring data between the data storage medium and the digital pen and a processor arranged to compare the document ID printed on the document and the document ID stored in the data storage medium and to further enable transfer of the captured data from the digital pen to the data storage medium only if the determined document ID and stored document ID match.

Preferably the data storage medium comprises an RFID tag and the digital pen transceiver comprises an RF antenna having a predetermined maximum operating range. Preferably the maximum operating range is 5 mm.

Additionally the digital pen imaging system may include an image sensor having a predetermined field of view and the document ID printed on the document is at a location such that when the RF antenna is within the operating range the document ID is within the field of view of the imaging sensor.

Additionally or alternatively, the document ID uniquely identifies the document.

Preferably the printed document ID is encoded.

Embodiments of the present invention are described below, by way of illustrative example only, with reference to the accompanying figures, of which:

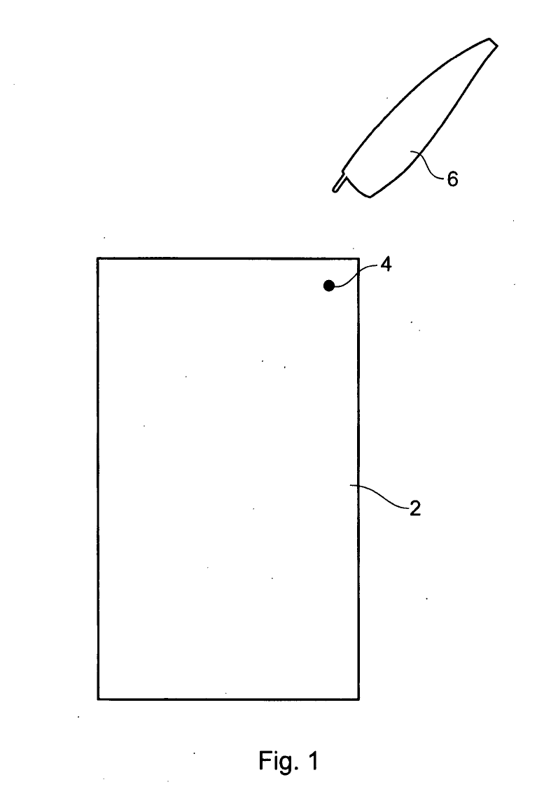

FIG. 1 is a schematic representation of a paper document, data storage medium and digital pen according to an embodiment of the present invention;

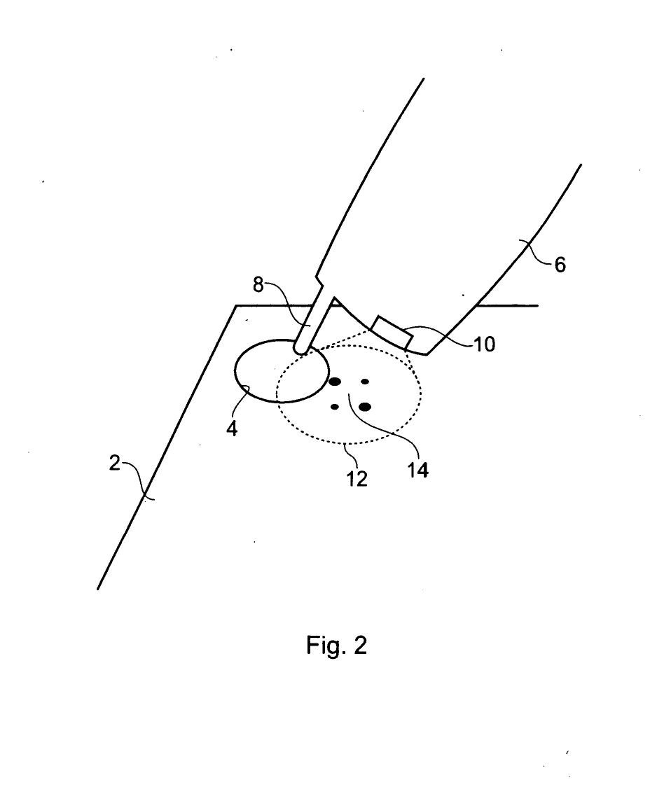

FIG. 2 is a schematic representation showing in detail the area of the paper document in the immediate vicinity of the data storage medium and its relationship to the digital camera;

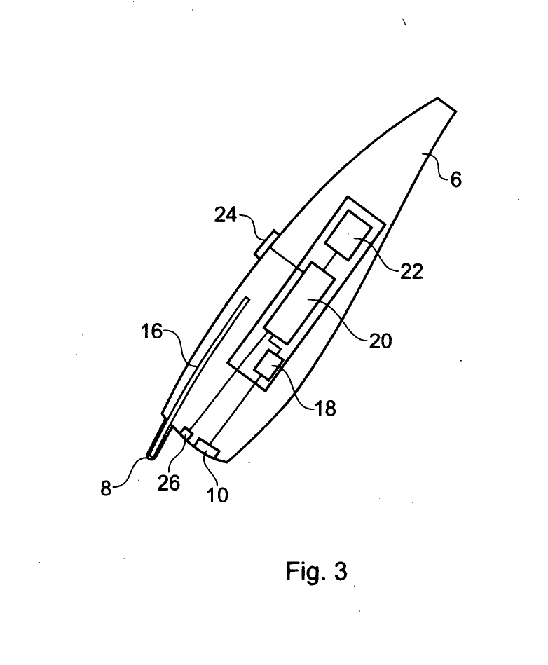

FIG. 3 is a schematic representation of a digital pen in accordance with embodiments of the present invention; and

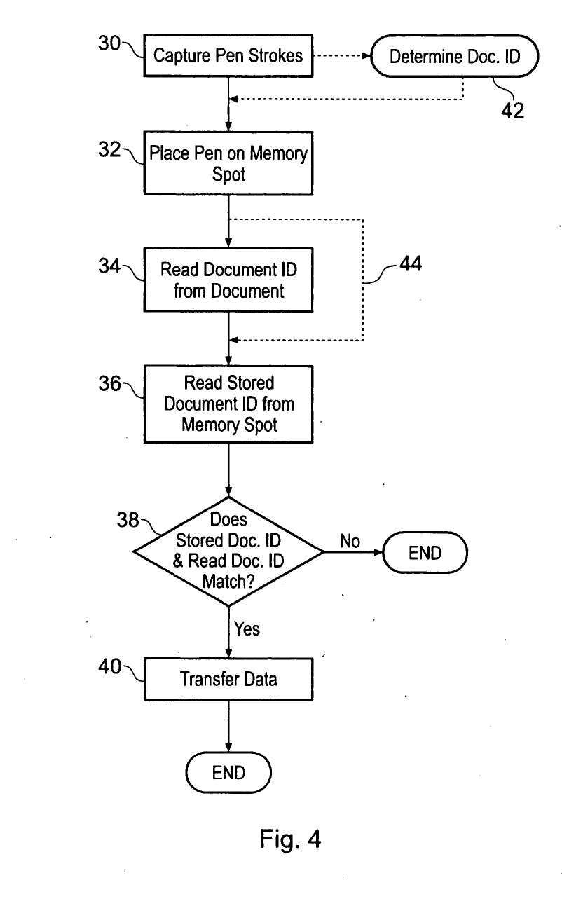

FIG. 4 schematically illustrates the method of operation of embodiments of the present invention.

FIG. 1 illustrates a schematic representation of a paper document 2, data storage medium 4 and digital pen 6 according to an arrangement of the present invention. The data storage medium is preferably an RFID memory tag that permits wireless communications with it using an appropriate RF antenna, which in embodiments of the present invention is included within the digital pen 6. The paper document 2 has a very fine pattern printed on it, which to the human eye merely appears as a slight shading of the paper surface. However, the paper pattern, which may for example comprise a pattern of very small dots such as that employed by Anoto AB, is capable of being discerned by a camera, or other suitable imaging system, incorporated within the digital pen 6. The pattern is arranged such that it is possible by determining the particular part of the pattern being viewed by the digital pen to determine the location of the pen with respect to the paper document. In embodiments of the present invention the fine pattern on the paper document is also used to uniquely identify the paper document. This is accomplished by ensuring that the portion of the pattern in the immediate vicinity of the RFID memory tag 4 that is visible to the digital pen 6 when the digital pen is placed on or over the RFID tag is unique to that particular paper document and thus forms a document ID. The unique identification pattern, more preferably the digital code represented by it, is stored on the RFID memory tag 4 affixed to the paper document 2. As a consequence, whenever the digital pen 6 is placed on the RFID memory tag 4 so as to access the tag, a comparison can be made between the document ID visible to the digital pen and the document ID stored on the RFID memory tag. Only if the two document IDs matched is full access to the RFID memory tag permitted. The document ID can be stored on the memory tag in any one of a number of different methods. For example, the identification code may be written and stored on the memory tag prior to the tag being embedded or affixed to a blank paper document and the paper document subsequently printed with the fine pattern, the pattern being dictated by the existing identification code. Alternatively, the memory tag may be embedded or affixed to a pre-patterned paper document and the identifying code present on the paper document adjacent to the memory spot subsequently determined and stored on the memory spot. Since the identification pattern present on the paper document and that stored on the memory tag must match, there is a high degree of certainty that the information written on a paper document and captured by the digital pen can only be written to the memory spot affixed to that paper document. This provides improved security of information.

In preferred embodiments of the present invention the RFID memory tag embedded or affixed to the paper document is of the kind produced by the current applicant known as a ‘Memory Spot’, which requires a radio frequency antenna to be brought within close proximity of the memory tag, preferably 5 mm or less.

In embodiments of the present invention the radio antenna used to read or write to the Memory Spot is incorporated into the digital pen 6 such that the pen must be placed effectively on top of the Memory Spot to allow data to be read or written from and to the Memory Spot. As a consequence, when a user touches the Memory Spot with the digital pen to initiate a read/write process there is no uncertainty about which Memory Spot is being accessed, even if a number of individual paper documents and associated Memory Spots are to hand. The likelihood of accidentally reading, or writing, data from or to a Memory Spot other than that associated with the paper document on which a digital pen has been used is minimal.

FIG. 2 schematically illustrates in greater detail the interaction between a digital pen and Memory Spot equipped paper document according to embodiments of the present invention. In addition to a conventional pen nib 8, the digital pen 6 includes an optical imaging device 10, such as a camera, the field of view of which is indicated by the broken circle 12. The field of view of the camera 10 is such that when the pen nib 8 is placed on, or near to, the actual Memory Spot 4, a portion of the fine pattern 14 printed on the paper document 2 is visible to the camera. The portion of the pattern 14 provides the unique identification of the paper document. As can be seen from FIG. 2, in preferred embodiments of the present invention the pattern is represented by a series of dots conforming to the pattern devised Anoto AB. However, in other embodiments the pattern may comprise of a different selection of dots or other indicia. In further embodiments a separate identification code or logo may be provided in the immediate vicinity of the Memory Spot that provides the unique identification of the paper document but is separate from the also existing paper pattern used to allow the digital pen to record pen strokes made on the paper. For example, a unique identification number may be represented by a very finely printed barcode.

An arrangement of the digital pen according to an embodiment of the present invention is schematically illustrated into FIG. 3. As previously mentioned, the digital pen includes a conventional pen nib 8, which is provided with a conventional ink refill 16, such as a ball pen type refill. Also located in the same end face of the digital pen 6 as the pen nib is an imaging sensor 10, such as an optical camera. This has a field of view, as described with relation to FIG. 2, that is sufficient to provide an image of the identification pattern located in the immediate vicinity of the Memory Spot 4 on a paper document whenever the base of the digital pen is placed on or above the Memory Spot. The image sensor is connected to an image processor 18 that is arranged to convert the signals from the image sensor 10 to appropriate digital signals representing the image captured by the image sensor. The image processor 18 is in turn connected to a main pen processor 20. The pen processor provides the main functionality of the digital pen by converting the sequence of images received from the image sensor and image processor as the pen is moved over the paper document 2 and processes these images to determine the actual pen strokes made by the pen and thus the data recorded on the paper. Connected to the pen processor 20 is a data storage module 22, such as conventional solid state memory module. The data storage module 22 is provided to allow the data processed by the pen processor 20 to be temporarily stored on the digital pen until such time as that data can be transferred to a Memory Spot. An actuation switch 24 may optionally be provided to control the operation of the pen processor, although this may also be incorporated within the pen cap such that the pen is actuated whenever the cap is removed or other alternative mechanisms provided to enable the processor when the pen is in use. An RFID antenna 26 is also provided in the same end face as image sensor 10 and is connected to the main pen processor 20. Consequently, the pen processor 20 controls the operation of the RF antenna 26 to allow data stored in the data storage module 22 to be written via the antenna to the co-located Memory Spot, and additionally to allow data held on such a Memory Spot to be read by the RF antenna by the pen processor 20. In the preferred embodiment illustrated in FIG. 3, the RF antenna 26 is located in the same end face of the digital pen as the image sensor 10 and the pen nib 8 such that the digital pen can be held in a conventional manner and simply placed over a Memory Spot located on the paper document when it is required to transfer data to or from the Memory Spot to the pen. However, in other embodiments the RF antenna may be located in other sections of the pen, such as in the opposite end face from the pen nib, such that the pen must be reversed in the users grip to allow data to be transferred, thus more clearly differentiating the data transfer operation from conventional pen usage and data capture.

FIG. 4 schematically illustrates the method steps involved in the use of the digital pen and paper document according to embodiments of the present invention. As an initial step 30 the digital pen is used as a conventional writing implement by a user with the user's pen strokes being captured by the imaging system and processor of the digital pen. In preferred embodiments, once the user has completed a writing process and wishes to transfer an electronic copy of the data captured by the digital pen, the user places the pen nib on, or in the immediate vicinity, the Memory Spot 4 affixed to the particular paper document 2 on which the user has been writing. This is illustrated as the second step 32 in FIG. 4. In the subsequent 34, an image of the document ID printed on the paper document 2 in the immediate vicinity of the Memory Spot 4 is captured by the imaging system of the digital pen, for example the imaging sensor and image processor 18 of the particular embodiment shown in FIG. 3. From this image the unique document identification for the paper document can be determined by the digital pen. The process of capturing and processing the document identification located on the paper document may in some embodiments be triggered simply by placing the digital pen within communication range of the Memory Spot 4, this being sensed by the RF antenna 26 located within the digital pen. Consequently, the process appears as completely automatic to the user whenever the user places the pen over the Memory Spot. Appropriate LEDs may be provided on the digital pen to provide confirmation to the user of the progress of this operation. In alternative embodiments a user activated switch may be provided on the digital pen operation of which instigates the document identification capture process. At subsequent step 36 the digital pen accesses the Memory Spot affixed to the paper document using the RF antenna 26 incorporated within the digital pen and retrieves the document identification data previously stored on the Memory Spot. The pen processor 20 of the digital pen then performs a comparison step 38 to determine if the document ID printed on the paper document and captured by the imaging system of the digital pen matches the document identification previously stored in the Memory Spot. If the match is positive the transfer of the pen stroke data, of the related data, stored in the short term memory of the digital pen is transferred to the Memory Spot, as indicated in step 40 on FIG. 4. However, if it is determined that the document identification stored in the Memory Spot and the document identification determined by the digital pen do not match one another, then the transfer of any further data either to or from the Memory Spot is prohibited. Again, one or more LEDs, or other such user indicators, may be provided on the digital pen to enable the user to monitor the progress and outcome of this process.

As previously mentioned, in alternative embodiments of the present invention the document ID may be printed on the document other than in the proximity of the Memory Spot. In this case the document ID can be determined by the pen processor either concurrently with or subsequent to the capture of the pen strokes, as indicated by alternative method step 42 in FIG. 4, and the step 34 of determining the document ID after placing the digital pen on the Memory Spot can be omitted, as indicated by the chained process line 44 in FIG. 4.

In further embodiments the user of the digital pen may be automatically identified using either the pen or image processors to monitor the perspective of the identification pattern as seen by the image sensor of the digital pen. Since different users will hold the pen in different ways, i.e. different angle from the vertical, different angle to the direction of writing etc., the perspective of the captured pattern image will differ between users, thus allowing users to be identified. This can be used to only allow certain users to access the Memory Spot on a particular document, for example, with the identity of authorised users being stored on the Memory Spot and an authorisation check taking place between the stored users and the present identified user, by means of the pen processor, prior to the transmission of any data to or from the Memory Spot. Other further security features may include using the digital pen's imaging system to identify particular printer parasitics in any printed sections of a document. Printer parasitics are minor flaws in the printing produced by a particular printer and vary from printer to printer and also from document to document even when printed on the same printer. Thus the printer parasitics present on a particular document may be used to provide a further unique identifier of that document.

By use of Memory Spot technology the security of the stored data is enhanced over previously available systems, since where multiple paper documents are in use there is no ambiguity as to which paper document and accessible Memory Spot is associated with, as may be the case with other RFID technologies in which the RFID tag can be accessed over a greater visible range. In addition, by associating the Memory Spot with a particular paper document via the document ID and requiring the digital pen to determine the document identification prior to accessing the Memory Spot a close bond is provided between the paper document digital pen and Memory Spot, thus preventing information captured via the digital pen on a first paper document being subsequently recorded on the Memory Spot of a second paper document, thus reducing the possibility for fraudulent use.

1. A method of recording data in a data storage medium affixed to a document, the document having a document ID printed thereon and the data storage medium having the document ID stored therein, the method comprising:
capturing data written onto the document by means of a digital pen, the digital pen having an imaging system;
determining, by means of the imaging system of the digital pen, the document ID printed on the document;
reading the document ID stored in the data storage medium; and
comparing the document ID determined by the digital pen with the document ID stored in the data storage medium and if there is a match transferring the captured data from the digital pen to the data storage medium.

2. The method of claim 1, wherein prior to reading the document ID stored in the data storage medium, the digital pen is placed within a predetermined distance from the data storage medium.

3. The method of claim 2, wherein the predetermined distance is 5mm.

4. The method of claim 2 or 3, wherein the document ID is located on the document within the predetermined distance from the data storage medium.

5. The method of any preceding claim, wherein the document ID comprises a data item uniquely identifying the document.

6. The method of any preceding claim wherein the document ID is in an encoded format.

7. The method of any preceding claim, wherein the document ID is located on the document at a plurality of places.

8. A system for recording data in a data storage medium affixed to a document, the system comprising:
a document having a document ID printed thereon;
a data storage medium affixed to the document and having the document ID stored therein; and
a digital pen having an imaging system arranged to determine the document ID printed on the document and capture data written on the document by the digital pen, a transceiver for transferring data between the data storage medium and the digital pen and a processor arranged to compare the document ID printed on the document and the document ID stored in the data storage medium and to further enable transfer of the captured data from the digital pen to the data storage medium only if the determined document ID and stored document ID match.

9. The system of claim 8, wherein the data storage medium comprises an RFID tag and the digital pen transceiver comprises an RF antenna having a predetermined maximum operating range.

10. The system of claim 9, wherein the predetermined maximum operating range is 5 mm.

11. The system of claim 8 or 9, wherein the digital pen imaging system includes an image sensor having a predetermined field of view and the document ID printed on the document is at a location such that when the RF antenna is within the operating range the document ID is within the field of view of the imaging sensor.

12. The system of any one of claims 8 to 11, wherein the document ID uniquely identifies the document.

13. The system of any one of claims 8 to 12, wherein the printed document ID is encoded.
